(19) United States
(12) Patent Application Publication
(10) Pub. No.: US 2023/0332911 A1
(43) Pub. Date: Oct. 19, 2023

(54) METHOD AND APPARATUS FOR DETERMINING ROADWORKS LOCATIONS

(71) Applicant: HERE GLOBAL B.V., Eindhoven (NL)

(72) Inventors: Amarnath NAYAK, West Mumbai (IN); Leon STENNETH, Chicago, IL (US); Alex AVERBUCH, Buffalo Grove, IL (US)

(73) Assignee: HERE GLOBAL B.V., EINDHOVEN (NL)

(21) Appl. No.: 17/724,254

(22) Filed: Apr. 19, 2022

(51) Int. Cl. G01C 21/36; G01C 21/00; G06V 20/58

(52) U.S. Cl. CPC G01C 21/3602; G01C 21/3822; G01C 21/3833; G06V 20/582

(57) ABSTRACT

A method, apparatus, and user interface for providing a roadworks location detection system is disclosed. For example, image data of at least one roadworks sign may be obtained and a location for the roadworks project may be determined based on the obtained image data. One or more road segments may then be identified, and the determined roadworks location associated with the one or more identified road segments to update a map layer of a geographic database and/or perform other actions.

### TECHNOLOGICAL FIELD

An example embodiment relates generally to a method, apparatus, computer readable storage medium, user interface and computer program product for determining roadworks locations and, more particularly, for determining the location of roadworks based upon image data.

### BACKGROUND

Modern vehicles include a plurality of different types of sensors for collecting a wide variety of information. These sensors include location sensors, such as global positioning system (GPS) sensors, configured to determine the location of the vehicle. Based upon the location of the vehicle, a variety of navigational, mapping and other services may be provided for manually driven vehicles as well as the provision of navigation and control of autonomous or semi-autonomous vehicles. Other examples of sensors include cameras or other imaging sensors that capture images of the environment including objects in the vicinity of the vehicle. The images that are captured may be utilized to determine the location of the vehicle with more precision. A more precise determination of the vehicle location may be useful in conjunction with the provision of navigational, mapping and other informational services for a manually driven vehicle. Additionally, the more precise determination of the vehicle location may provide for the improved navigation and control of an autonomous or semi-autonomous vehicle by taking into account the location of other objects, such as other vehicles, in proximity to the vehicle carrying the sensors.

The sensors on board vehicles therefore collect a wide variety of data that may be utilized for various purposes. However, these sensors currently on-board vehicles do have limitations and do not provide all of the different types of information that would be useful in various applications. One specific example of a current limitation is in the generation of route guidance and automated vehicle controls in certain scenarios.

### BRIEF SUMMARY

A method, apparatus, computer readable storage medium, user interface, and computer program product are provided in accordance with an example embodiment to determine and predict the location of roadworks projects. In this regard, the method, apparatus, computer readable storage medium, and computer program product of an example embodiment may utilize image data collected from roadworks signs to determine and predict one or more roadworks locations. The reliance upon the collection and analysis of image data may supplement the information provided by other sensors and allow for the provision of different information, such as the type of roadworks which is useful for a variety of applications. As an example, the determination of the location of a roadworks project may be useful in relation to the provision of more relevant information. Such uses include routing information, alerts, etc. By way of another example, the identification and/or prediction of roadworks locations may also be useful for federal, state, local or other governmental or regulatory officials that design and maintain the roads and sidewalks.

One embodiment may be described as a method for providing a roadworks detection system comprising obtaining image data of at least one road sign and then determining a roadworks location based on the obtained image data. After this, one or more road segments may be identified and then the determined roadworks location may be associated with the one or more identified road segments and used to update a map layer of a geographic database. The embodiment above may further comprise receiving an indication of a location of the vehicle and identifying one or more roadworks proximate the location of the vehicle. This embodiment may also include determining a confidence interval associated with the determined roadworks location and updating a map layer with the confidence interval. The confidence interval associated with the determined roadworks location may be based, at least in part, on the period of time the at least one sign has been present in a given location and updating a map layer with the confidence interval.

In some embodiments, the method may further comprise identifying at least one additional roadworks location based on road segments similarly situated to the previously identified roadworks location. Alerts and/or route guidance may be generated in response to the determined roadworks location in the embodiments disclosed and the image data of road signs, etc. may be captured by a vehicle camera system.

Another embodiment may be described as an apparatus configured to predict roadworks location, the apparatus comprising at least one processor and at least one memory storing computer program code, the at least one memory and the computer program code configured to, with the processor, cause the apparatus to at least obtain image data of at least one road sign and determine a roadworks location based on the obtained image data. The apparatus may then identify one or more road segments and associate the determined roadworks location with one or more identified road segments to update a map layer of a geographic database.

This apparatus and others may also be further configured to, with the processor, cause the apparatus to receive an indication of a location of the vehicle, and wherein the at least one memory and the computer program code are configured to, with the processor, cause the apparatus to identify one or more roadworks locations proximate the location of the vehicle. The apparatus may also determine a confidence interval associated with the determined roadworks location and update a map layer with the confidence interval. This confidence interval, associated with the determined roadworks location, may be based at least in part on the period of time the at least one sign has been present in a given location. The apparatus described herein may also be configured to, with the processor, cause the apparatus to obtain the image data via a vehicle camera system and generate route guidance.

Yet another embodiment may be described as a user interface (UI) for providing a user with a route to a destination, comprising the steps of receiving input upon a user device from the user that indicates a destination and then accessing a geographic database to obtain data that represent roads in a region in which the user device is operating. The UI may then carry out the step of determining a route to the destination by selecting road segments to form a continuous path to the destination and displaying the determined route or portion thereof to the user, the determined route avoiding at least one road segment in response to a determined roadworks location. The route determined for the vehicle may avoid one or more roadworks locations proximate the location of the vehicle. The roadworks location may be derived at least in part on image data obtained via a vehicle camera system. The user interface may also provide alerts and route guidance in response to the determined roadworks location. All this information may be displayed on an end user device (e.g., smartphone, tablet, etc.) and/or in a motor vehicle (e.g., built-in display).

Also, a computer program product may be provided. For example, a computer program product comprising instructions which, when the program is executed by a computer, cause the computer to carry out the steps described herein.

### BRIEF DESCRIPTION OF THE DRAWINGS

Having thus described certain embodiments of the invention in general terms, reference will now be made to the accompanying drawings, which are not necessarily drawn to scale, and wherein:

FIG. 1 is a block diagram of an apparatus that may be specifically configured in accordance with an example embodiment;

FIG. 2 is a block diagram of a geographic database of an example embodiment of the apparatus;

FIG. 3A is a flowchart illustrating the operations performed, such as by the apparatus of FIG. 1, in order for an apparatus to identify a roadworks location;

FIG. 3B is a flowchart illustrating the operations performed, such as by the apparatus of FIG. 1, in order to provide a graphical user interface and/or functions thereof;

FIG. 3C is a flowchart illustrating the operations performed, such as by the apparatus of FIG. 1, in order to train machine learning models to predict roadworks locations;

FIG. 4 is a graphical representation of a road upon which a passenger car is present with a road sign proximate to the road;

FIG. 5 is another graphical representation of a road upon which a passenger car is present with road sign proximate to the road.

### DETAILED DESCRIPTION

Some embodiments of the present invention will now be described more fully hereinafter with reference to the accompanying drawings, in which some, but not all, embodiments are shown. Indeed, various embodiments may be embodied in many different forms and should not be construed as limited to the embodiments set forth herein; rather, these embodiments are provided so that this disclosure will satisfy applicable legal requirements. Like reference numerals refer to like elements throughout. As used herein, the terms “data,” “content,” “information,” and similar terms may be used interchangeably to refer to data capable of being transmitted, received and/or stored in accordance with embodiments of the present invention. Thus, use of any such terms should not be taken to limit the spirit and scope of embodiments of the present invention.

A system, method, apparatus, user interface, and computer program product are provided in accordance with an example embodiment to determine a roadworks location based on image data. In order to determine the roadworks location, the system, method, apparatus, non-transitory computer-readable storage medium, and computer program product of an example embodiment are configured to obtain image data of at least one road sign and determine a roadworks location based on the obtained image data. The image data may be obtained from a vehicle camera system, traffic cameras, etc. The system in this embodiment may then identify one or more road segments and associate the determined roadworks location with one or more related road segments to update a map layer of a geographic database.

The system, apparatus, method, etc. described above may be any of a wide variety of computing devices and may be embodied by either the same or different computing devices. The system, apparatus, etc. may be embodied by a server, a computer workstation, a distributed network of computing devices, a personal computer or any other type of computing device. The system, apparatus, etc. configured to detect and predict roadworks may similarly be embodied by the same or different server, computer workstation, distributed network of computing devices, personal computer or other type of computing device.

Alternatively, the system, etc. may be embodied by a computing device on board a vehicle, such as a computer system of a vehicle, e.g., a computing device of a vehicle that supports safety-critical systems such as the powertrain (engine, transmission, electric drive motors, etc.), steering (e.g., steering assist or steer-by-wire), and/or braking (e.g., brake assist or brake-by-wire), a navigation system of a vehicle, a control system of a vehicle, an electronic control unit of a vehicle, an autonomous vehicle control system (e.g., an autonomous-driving control system) of a vehicle, a mapping system of a vehicle, an Advanced Driver Assistance System (ADAS) of a vehicle), or any other type of computing device carried by the vehicle. Still further, the apparatus may be embodied by a computing device of a driver or passenger on board the vehicle, such as a mobile terminal, e.g., a personal digital assistant (PDA), mobile telephone, smart phone, personal navigation device, smart watch, tablet computer, or any combination of the aforementioned and other types of portable computer devices.

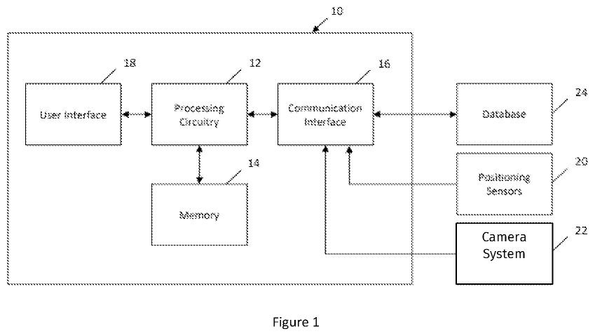

Regardless of the manner in which the system, apparatus, etc. is embodied, however, an apparatus 10 includes, is associated with, or is in communication with processing circuitry 12, memory 14, a communication interface 16 and optionally a user interface 18 as shown in FIG. 1. In some embodiments, the processing circuitry (and/or co-processors or any other processors assisting or otherwise associated with the processing circuitry) can be in communication with the memory via a bus for passing information among components of the apparatus. The memory can be non-transitory and can include, for example, one or more volatile and/or non-volatile memories. In other words, for example, the memory may be an electronic storage device (for example, a computer readable storage medium) comprising gates configured to store data (for example, bits) that can be retrievable by a machine (for example, a computing device like the processing circuitry). The memory can be configured to store information, data, content, applications, instructions, or the like for enabling the apparatus to carry out various functions in accordance with an example embodiment of the present disclosure. For example, the memory can be configured to buffer input data for processing by the processing circuitry. Additionally, or alternatively, the memory can be configured to store instructions for execution by the processing circuitry.

The processing circuitry 12 can be embodied in a number of different ways. For example, the processing circuitry may be embodied as one or more of various hardware processing means such as a processor, a coprocessor, a microprocessor, a controller, a digital signal processor (DSP), a processing element with or without an accompanying DSP, or various other processing circuitry including integrated circuits such as, for example, an ASIC (application specific integrated circuit), an FPGA (field programmable gate array), a microcontroller unit (MCU), a hardware accelerator, a special-purpose computer chip, or the like. As such, in some embodiments, the processing circuitry can include one or more processing cores configured to perform independently. A multi-core processor can enable multiprocessing within a single physical package. Additionally, or alternatively, the processing circuitry can include one or more processors configured in tandem via the bus to enable independent execution of instructions, pipelining and/or multithreading.

In an example embodiment, the processing circuitry 12 can be configured to execute instructions stored in the memory 14 or otherwise accessible to the processing circuitry. Alternatively, or additionally, the processing circuitry can be configured to execute hard coded functionality. As such, whether configured by hardware or software methods, or by a combination thereof, the processing circuitry can represent an entity (for example, physically embodied in circuitry) capable of performing operations according to an embodiment of the present disclosure while configured accordingly. Thus, for example, when the processing circuitry is embodied as an ASIC, FPGA or the like, the processing circuitry can be specifically configured hardware for conducting the operations described herein. Alternatively, as another example, when the processing circuitry is embodied as an executor of software instructions, the instructions can specifically configure the processing circuitry to perform the algorithms and/or operations described herein when the instructions are executed. However, in some cases, the processing circuitry can be a processor of a specific device (for example, a computing device) configured to employ an embodiment of the present disclosure by further configuration of the processor by instructions for performing the algorithms and/or operations described herein. The processing circuitry can include, among other things, a clock, an arithmetic logic unit (ALU) and/or one or more logic gates configured to support operation of the processing circuitry.

The apparatus 10 of an example embodiment can also include the communication interface 16 that can be any means such as a device or circuitry embodied in either hardware or a combination of hardware and software that is configured to receive and/or transmit data from/to other electronic devices in communication with the apparatus, such as a database 24 which, in one embodiment, comprises a map database that stores data (e.g., one or more map objects, POI data, etc.) generated and/or employed by the processing circuitry 12. Additionally, or alternatively, the communication interface can be configured to communicate in accordance with various wireless protocols including Global System for Mobile Communications (GSM), such as but not limited to Long Term Evolution (LTE), 3G, 4G, 5G, 6G, etc. In this regard, the communication interface can include, for example, an antenna (or multiple antennas) and supporting hardware and/or software for enabling communications with a wireless communication network. In this regard, the communication interface can include, for example, an antenna (or multiple antennas) and supporting hardware and/or software for enabling communications with a wireless communication network. Additionally, or alternatively, the communication interface can include the circuitry for interacting with the antenna(s) to cause transmission of signals via the antenna(s) or to handle receipt of signals received via the antenna(s). In some environments, the communication interface can alternatively or also support wired communication and/or may alternatively support vehicle to vehicle or vehicle to infrastructure wireless links.

In certain embodiments, the apparatus 10 can be equipped or associated with one or more positioning sensors 20, such as one or more GPS sensors, one or more accelerometer sensors, one or more light detection and ranging (LiDAR) sensors, one or more radar sensors, one or more gyroscope sensors, and/or one or more other sensors. Any of the one or more sensors may be used to sense information regarding movement, positioning and location, and/or orientation of the apparatus for use, such as by the processing circuitry 12, in navigation assistance and/or autonomous vehicle control, as described herein according to example embodiments.

In certain embodiments, the apparatus 10 may further be equipped with or in communication with one or more camera systems 22. In some example embodiments, the one or more camera systems 22 can be implemented in a vehicle or other remote apparatuses.

For example, the one or more camera systems 22 can be located upon a vehicle or proximate to it (e.g., traffic cameras, etc.). While embodiments may be implemented with a single camera such as a front facing camera in a consumer vehicle, other embodiments may include the use of multiple individual cameras at the same time. A helpful example is that of a consumer sedan driving down a road. Many modern cars have one or more cameras installed upon them to enable automatic braking and other types of assisted or automated driving. Many cars also have rear facing cameras to assist with automated or manual parking. In one embodiment of the current system, apparatus, method, etc. these cameras are utilized to capture images of road signs, streets, etc. as the sedan travels around. The system takes these captured images (via the camera systems 22) and analyzes them to determine if roadwork is occurring on a certain street. Various types of roadwork may be detected via any functional means including but not limited to the use of optical character recognition (OCR) and natural language processing (NLP) to read and classify the type of roadwork occurring on a given street as detailed on an associated road sign.

The data captured concerning the vehicles present may also come from traffic cameras, security cameras, or any other functionally useful source (e.g., historic data, satellite images, websites, etc.).

The analysis of the image data of the vehicle may be carried out by a machine learning model. This model may utilize any functionally useful means of analysis to identify roadworks on a given roadway, road segment, or in a general area. The system, in this embodiment, may also examine relevant proximate points of interest (POIs), map objects, road geometries, animate objects, etc. which could suggest the presence of roadworks.

The locations of the vehicle, road sign(s), any relevant points of interest (POIs), and other types of data which are utilized by various embodiments of the apparatus may each be identified in latitude and longitude based on a location of the vehicle using a sensor, such as a GPS sensor to identify the location of the vehicle. The POIs, map objects, infrastructure, etc. identified by the system may also be detected via the camera systems 22.

In certain embodiments, information detected by the one or more cameras can be transmitted to the apparatus 10, such as the processing circuitry 12, as image data. The data transmitted by the one or more cameras can be transmitted via one or more wired communications and/or one or more wireless communications (e.g., near field communication, or the like). In some environments, the communication interface 16 can support wired communication and/or wireless communication with the one or more camera sensors.

The apparatus 10 may also optionally include a user interface 18 that may, in turn, be in communication with the processing circuitry 12 to provide output to the user and, in some embodiments, to receive an indication of a user input. As such, the user interface may include a display and, in some embodiments, may also include a keyboard, a mouse, a joystick, a touch screen, touch areas, soft keys, one or more microphones, a plurality of speakers, or other input/output mechanisms. In one embodiment, the processing circuitry may comprise user interface circuitry configured to control at least some functions of one or more user interface elements such as a display and, in some embodiments, a plurality of speakers, a ringer, one or more microphones and/or the like. The processing circuitry and/or user interface circuitry embodied by the processing circuitry may be configured to control one or more functions of one or more user interface elements through computer program instructions (for example, software and/or firmware) stored on a memory accessible to the processing circuitry (for example, memory 14, and/or the like).

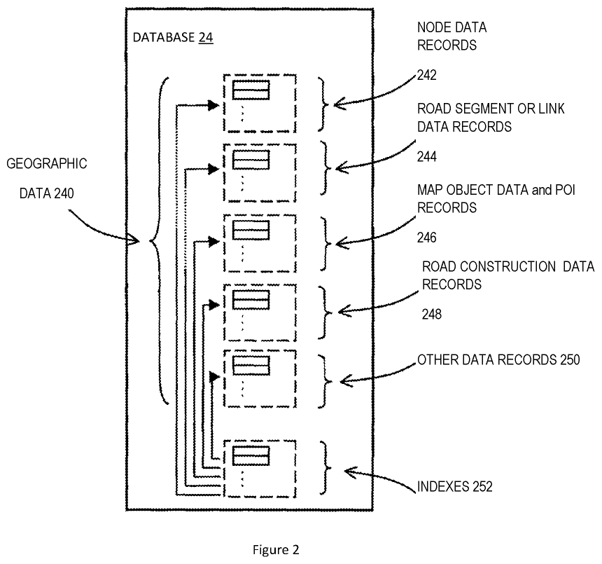

Turning to FIG. 2, the map or geographic database 24 may include various types of geographic data 240. This data may include but is not limited to node data 242, road segment or link data 244, map object and point of interest (POI) data 246, road construction (roadworks) data records 248, or the like (e.g., other data records 250 such as traffic data, sidewalk data, etc.). Other data records may include computer code instructions and/or algorithms for executing a machine learning model that is capable of providing a prediction of adverse road locations. The other records may further include verification data indicating: (1) whether a verification of a prediction for an adverse road location was conducted; (2) whether the verification validates the prediction; or (3) a combination thereof.

In one embodiment, the following terminology applies to the representation of geographic features in the database 24. A “Node”—is a point that terminates a link, a “road/line segment”—is a straight line connecting two points, and a “Link” (or “edge”) is a contiguous, non-branching string of one or more road segments terminating in a node at each end. In one embodiment, the database 24 follows certain conventions. For example, links do not cross themselves and do not cross each other except at a node. Also, there are no duplicated shape points, nodes, or links. Two links that connect each other have a common node.

The map database 24 may also include cartographic data, routing data, and/or maneuvering data as well as indexes 252. According to some example embodiments, the road segment data records may be links or segments representing roads, streets, or paths, as may be used in calculating a route or recorded route information for determination of one or more personalized routes. The node data may be end points (e.g., intersections) corresponding to the respective links or segments of road segment data. The road link data and the node data may represent a road network, such as used by vehicles, cars, trucks, buses, motorcycles, bikes, scooters, and/or other entities.

Optionally, the map database may contain path segment and node data records or other data that may represent pedestrian paths or areas in addition to or instead of the vehicle road record data, for example. The road/link segments and nodes can be associated with attributes, such as geographic coordinates, street names, address ranges, speed limits, turn restrictions at intersections, and other navigation related attributes, as well as POIs, such as fueling stations, hotels, restaurants, museums, stadiums, offices, auto repair shops, buildings, stores, parks, etc. The map database can include data about the POIs and their respective locations in the POI records. The map database may include data about places, such as cities, towns, or other communities, and other geographic features such as bodies of water, mountain ranges, etc. Such place or feature data can be part of the POI data or can be associated with POIs or POI data records (such as a data point used for displaying or representing a position of a city). In addition, the map database can include event data (e.g., traffic incidents, construction activities, scheduled events, unscheduled events, etc.) associated with the POI data records or other records of the map database.

The map database 24 may be maintained by a content provider e.g., the map data service provider and may be accessed, for example, by the content or service provider processing server. By way of example, the map data service provider can collect geographic data and dynamic data to generate and enhance the map database and dynamic data such as traffic-related data contained therein. There can be different ways used by the map developer to collect data. These ways can include obtaining data from other sources, such as municipalities or respective geographic authorities, such as via global information system databases. In addition, the map developer can employ field personnel to travel by vehicle along roads throughout the geographic region to observe features and/or record information about them, for example. Also, remote sensing, such as aerial or satellite photography and/or LiDAR, can be used to generate map geometries directly or through machine learning as described herein. However, the most ubiquitous form of data that may be available is vehicle data provided by vehicles, such as mobile device, as they travel the roads throughout a region.

The map database 24 may be a master map database, such as an HD map database, stored in a format that facilitates updates, maintenance, and development. For example, the master map database or data in the master map database can be in an Oracle spatial format or other spatial format (e.g., accommodating different map layers), such as for development or production purposes. The Oracle spatial format or development/production database can be compiled into a delivery format, such as a geographic data files (GDF) format. The data in the production and/or delivery formats can be compiled or further compiled to form geographic database products or databases, which can be used in end user navigation devices or systems.

For example, geographic data may be compiled (such as into a platform specification format (PSF) format) to organize and/or configure the data for performing navigation-related functions and/or services, such as route calculation, route guidance, map display, speed calculation, distance and travel time functions, and other functions, by a navigation device, such as by a vehicle represented by mobile device, for example. The navigation-related functions can correspond to vehicle navigation, pedestrian navigation, or other types of navigation. The compilation to produce the end user databases can be performed by a party or entity separate from the map developer. For example, a customer of the map developer, such as a navigation device developer or other end user device developer, can perform compilation on a received map database in a delivery format to produce one or more compiled navigation databases.

As mentioned above, the map database 24 may be a master geographic database, but in alternate embodiments, a client-side map database may represent a compiled navigation database that may be used in or with end user devices to provide navigation and/or map-related functions. For example, the map database may be used with the mobile device to provide an end user with navigation features. In such a case, the map database can be downloaded or stored on the end user device which can access the map database through a wireless or wired connection, such as via a processing server and/or a network, for example.

The data records for change of direction indicators 248 may include various points of data such as, but not limited to: relative size of objects, movement patterns, the time of day, any sensor data acquired from one or more sensors of a vehicle; travel data of a vehicle, GPS coordinates for a given detected relationship, etc.

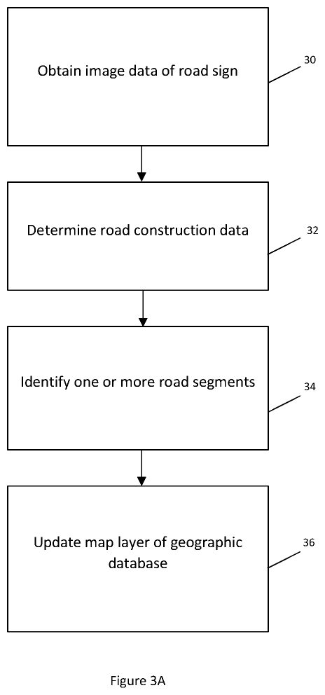

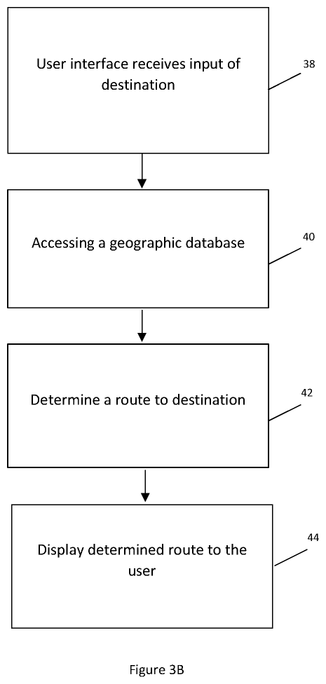

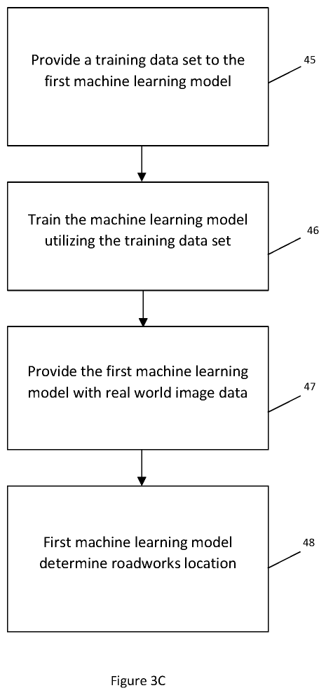

FIG. 3A is a flowchart which demonstrates how the apparatus 10 identifies change of direction indicators for vehicles. More, fewer, or different acts or steps may be provided. At a first step (block 30) the apparatus may obtain one or more images of at least one road sign. The images may be obtained from the camera of an end user device such as a smart phone, the camera system of a vehicle, or even traffic cameras, etc. The apparatus may be trained to analyze the image data (see FIG. 3C) via machine learning model or any other functionally capable means to identify road work/road construction data from a given road sign. The signs may include but are not limited to the simple “ROAD WORK AHEAD” orange diamond sign typically found on American roadways and other more complicated signs or those used in other countries, jurisdictions, etc. For example, some road signs contain more detailed information such as the time, date, location, etc. for a roadwork project. These more detailed signs might be physical printed signs placed along a road or electronic signs and boards which inform users of road construction projects, delays, etc.

Once these images are obtained, the apparatus may then determine road construction data at another step (block 32). The road construction data may be obtained from the road sign(s) above and other sources (e.g., online postings about upcoming construction) and the data may include but is not limited to the type of construction project, the time it is scheduled to take, the time it has taken to complete thus far (sourced from past data records, online information, etc.), the time of day the construction is to take place, how long similar road construction projects have taken, etc.

Examples of the type of road construction project may include highway, street, and road construction, resurfacing, or repair of: whitetopping roads, polymer fiber reinforced concrete roads, bituminous roads, composite pavement roads, gravel roads, or earthen roads. Yet other types of roadworks projects may include hard infrastructure construction, restoration, and repair including bridges, mass transit infrastructure, etc. Other types of public work's projects which may impact usage of a given roadway which the present apparatus can account for include works projects for water supply, waste management, power generation and transmission, etc.

For example, some public works projects indicate long traffic delays, or that a detour might occur. An example of this is a bridge being restored. When such a project is about to get underway, it is common to set up road signs or send out notices via electronic sign boards, SMS alerts, etc. As end users of the present apparatus drive by these road signs, the apparatus may capture information pertaining to the type, length, scope, etc. of the construction project. Capture of this information may be achieved, in some embodiments, by use of optical character recognition (OCR) and/or natural language processing (NLP) algorithms.

Once a roadworks location has been identified, the apparatus may then identify one or more road segments (block 34) upon which the roadwork is occurring. The identification of the relevant road segments may be done via a vehicle's onboard GPS (see FIG. 1) or any other functional means. Once identified, the apparatus may then update a map layer of a geographic database (block 36). The updating of the map layer may include but is not limited to identifying/associating locations of the identified relationships with certain road segments and then providing a data indicator or flag to mark that road segment or attribute (metadata) that can be used as an identifier when needed to access or retrieve the road segments for various navigation functions. This data can also be used to generate alerts and analyze other similarly situated road segments for the potential delays, route changes, etc. a given roadworks project might pose. The road segment data may also include sidewalk data or areas included in/associated with the road segment records or the road segment records may represent path records such as sidewalks, hiking trails, etc.

Turning to FIG. 3B, the apparatus 10 may support a user interface 18 (as shown in FIG. 1). More, fewer, or different acts or steps may be provided. At a first step, the user interface may receive an input of destination from an end user (block 38). This input of destination may be received via an end user device graphical user interface (GUI) running upon a smartphone, tablet, integrated vehicle navigation system, etc. Once a destination is input, the apparatus may then access a geographic database (block 40) and determine a route to the input destination (block 42). The determined route may, in some embodiments, avoid at least one road segment in response to a determined roadworks location. As mentioned above, the determination of indicator may be based on any functionally capable means including identification of an actual physical road sign detailing such road work and/or various other data sources.

Notwithstanding how the apparatus generates a determination of a roadworks location, this information may then be used to route the end user towards or away from certain road segments when generating a route. The route determined by the apparatus 10 may then be displayed to then end user (block 44) via the same or a different user interface. The apparatus can take any number of additional actions (or in place of) what is called for in block 44. For example, the apparatus may provide audio guidance instead of a visual display. The navigation instructions may also be provided to an autonomous vehicle for routing (for example, without any display to the user). It should also be noted the UI can be run by a processor and stored upon one or more types of memory in some embodiments.

Referring now to FIG. 3C, the operations performed, such as by the apparatus 10 of FIG. 1, in order to train a machine learning model to detect roadworks location(s). More, fewer, or different acts or steps may be provided. As shown in block 45, the apparatus includes means, such as the processing circuitry 12, memory 14, the communication interface 16 or the like, for providing a training data set that includes a plurality of training examples. In this regard, the training data set may be provided by access by the processing circuitry of the training data set stored by the memory. Alternatively, the training data set may be provided by access by the processing circuitry to a database 24 or other memory device that either may be a component of the apparatus or may be separate from, but accessible to the apparatus, such as the processing circuitry, via the communication interface. It should be noted the system apparatus may utilize more than one machine learning model to carry out the steps described herein.

In accordance with an example embodiment, the apparatus 10 also includes means, such as the processing circuitry 12, the memory 14 or the like, configured to train a machine learning model utilizing the training data set (block 46). The machine learning model, as trained, is configured to detect and predict vehicles changing directions. The prediction may be based at least in part upon image data of road signs.

The apparatus 10, such as the processing circuitry 12, may train any of a variety of machine learning models to identify road work project signs based upon a single or plurality of images. Examples of machine learning models that may be trained include a decision tree model, a random forest model, a neural network, a model that employs logistic regression or the like. In some example embodiments, the apparatus, such as the processing circuitry, is configured to separately train a plurality of different types of machine learning models utilizing the same training data including the same plurality of training examples. After having been trained, the apparatus, such as the processing circuitry, is configured to determine which of the plurality of machine learning models predicts vehicles based upon image data with the greatest accuracy. The machine learning model that has been identified as most accurate is thereafter utilized.

In one example, the machine learning model may be a deep learning neural network computer vision model that utilizes image data of road signs to automatically identify them. A training example for this first machine learning model may also include image data of known types of road work projects. Known projects could include but are not limited to highway, street, and road construction, resurfacing, or repair of whitetopping roads, polymer fiber reinforced concrete roads, bituminous roads, composite pavement roads, gravel roads, earthen roads. Yet other types of roadworks projects may include hard infrastructure construction, restoration, and repair including bridges, mass transit infrastructure, etc. Other types of public work's projects which may impact usage of a given roadway which the present apparatus can account for include works projects for water supply, waste management, power generation and transmission, etc. Various images of different types of projects are provided to the machine learning model to train and improve its accuracy.

In some example embodiments, a balance or trade-off between the accuracy with which the vehicles are identified and the efficiency with which the machine learning model identifies the objects is considered. For example, a first set of images may produce the most accurate identification, but a second combination of images may produce an identification of objects that is only slightly less accurate, but that is significantly more efficient in terms of its prediction. Thus, the second combination of images that provide for sufficient, even though not the greatest, accuracy, but does so in a very efficient manner may be identified by the apparatus 10, such as the processing circuitry 12, as the preferred images to be provided to the machine learning model in order to identify vehicles in subsequent instances.

In some embodiments, a training example also includes information regarding a map object, such as a map object that is located at the location at which the image data was captured. One example of a map object is a bridge, and another example of a map object is a railroad crossing. A wide variety of other map objects may exist including, for example, manhole covers, transitions between different types of road surfaces, medians, parking meters, various forms of infrastructure, or the like. As described in more detail below, the map object that is included in a training example may be determined or provided in various manners. For example, the map object may be defined, either manually or automatically, by reference to a map database 24 and identification of a map object at the same location or at a location proximate, such as within a predefined distance of, the location at which the corresponding image data was captured. The training example may also include point of interest (POI) data. A POI may be something like a restaurant, park, school, bus stop, etc. Relevant POIs may also be defined, either manually or automatically, by reference to a map database 24 and identification of a POI at the same location or at a location proximate, such as within a predefined distance of, the location at which the corresponding image data was captured. The location of relevant POIs and/or map objects may be found by GPS coordinates or any other functionally capable means.

Various other types of data may also be utilized to train the machine learning model. Such additional data may include but is not limited to data concerning typical length of a given roadwork project. For example, in some settings many road signs are not taken down promptly and/or do not account for construction delays. In some embodiments, data concerning not only the type of road sign present and the information displayed on it, but also how long the road sign and roadworks project has been present may be accounted for. For example, on a rural highway a road sign indicating roadwork is to occur from April-May of 2022. If the road sign is still present in August 2022 there is a distinct possibility that this road sign has been left in place by accident or that the road construction has been delayed past the stated period on the actual sign. As cars, trucks, etc. drive by this sign, the apparatus 10 may continually read and re-read the sign along with other various data points (time, date, if road work equipment is present, etc.) to confirm if the sign is accurate or not. From this, various roadworks locations may be identified by the apparatus 10 and such information used for alerts, routing etc.

Yet other various types of data may also be utilized when training the machine learning model including map geometry data, historic data, etc. Ground truth data may also be utilized with a combination of these different features for supervised machine learning.

Once trained, the machine learning model may then be provided various real-world data as mentioned in block 47 and used to determine roadworks locations based on the various data points above and others (block 48).

A non-limiting example of the apparatus 10 detecting and/predicting a roadworks location is that of a car driving along a 2-lane highway. As the car drives down the road, it comes upon a sign which says, “Road Construction Ahead 2 Miles”. The apparatus 10 will capture images of the road sign via the car's camera system 22. The image data captured is provided to the machine learning model which, when trained, may identify the road sign as well as any relevant road construction objects in proximity to the roadway (e.g., construction vehicles, map objects, POIs, etc.).

One such object, in this example, could be a dump truck located proximate to the roadway. The type of object (e.g., road construction equipment) determination and the relevant other information identified may be provided to the machine learning model. The machine learning model will then be able to predict if and where roadwork is occurring on a given roadway. In this example, since the car has passed a road sign indicating roadwork is occurring and there is construction equipment present, the apparatus 10 may predict that there is a high likelihood road construction is occurring.

The machine learning model in this example makes its determination based on a combination of specific factors (map data, image data, etc.), and the model predicts the presence of roadworks because of specific factors in a specific combination or configuration are present. The factors in this example may include the image data of the road sign and dump truck (together in one image or as separate images), image data of the roadways, image data of objects proximate to the roadway (e.g., dumpsters, construction materials, construction workers, etc.) as well as time of day data, historic data, etc. This set of data, provided to the model, matches (or is like) the factors used in the training process (in this example). This allows the machine learning model to predict a roadworks location given the location, time of day, vehicles, and animate objects present, etc.

The determination of the presence of a road construction can then be utilized in various ways. The apparatus 10 may alert the driver of the sedan (and others) via graphical user interface that there could be a delay or risk ahead. The apparatus may also update one or more map layers and/or databases to account for this determination. In some embodiments, the identified roadworks location may be used to activate autonomous or highly assisted driving features. For example, if the sedan discussed above had self-driving capabilities the apparatus 10 could activate the self-driving mode in response to the road construction to avoid congestion caused by it (and improve safety by avoiding construction workers).

The determined roadworks location may be utilized in other ways. For example, the apparatus 10 may provide to the end user updated route guidance which avoids certain areas with potential road construction. Continuing with the example above, the apparatus 10 may look at existing map data to determine a better route which avoids the construction all together.

As mentioned before, the apparatus 10 features one or more machine learning models. This model and other data may be used by the apparatus 10 to not only analyze real time driving situations as mentioned above but also examine existing map data to identify other similarly situated roadways. These similar roadways will have similar POIs, map objects, etc. So, for example, if there was another roadway with a dump truck proximate to it (but no road sign), the apparatus 10 may be able to detect such a similar roadway and provide alerts, route guidance, etc. to an end user to avoid potential risks and/or traffic.

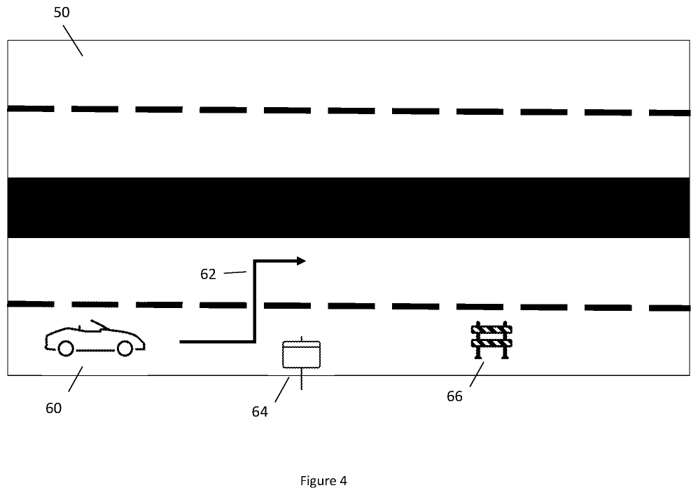

Turning to FIG. 4, some of the examples discussed above are illustrated. Specifically, a sedan 60 is shown driving down a roadway 50. On the roadway 50 there is a road sign 64 and a road works project 66 ahead (proximate to the roadway). As shown in FIG. 4, the sedan 60 is utilizing the apparatus 10 to predict the presence of the road works project 66. The apparatus 10 identifies the road sign 64 via images from the camera system 22, traffic cameras, etc. and feeds those images into the machine learning model which determines the type of road sign present (e.g., a road construction sign, electronic sign, speed limit sign, etc.). The apparatus then takes this data along with relevant other information such as the image data of the actual road works/construction project 66 and feeds it back to the machine learning model (or to another model, algorithm, etc.) to determine if there is likely road construction on a given roadway.

It should be noted that the sedan 60 in this example represents any vehicle. Such vehicles may be standard gasoline powered vehicles, hybrid vehicles, an electric vehicle, a fuel cell vehicle, and/or any other mobility implement type of vehicle (e.g., bikes, scooters, etc.). The vehicle includes parts related to mobility, such as a powertrain with an engine, a transmission, a suspension, a driveshaft, and/or wheels, etc. The vehicle may be a non-autonomous vehicle or an autonomous vehicle. The term autonomous vehicle may refer to a self-driving or driverless mode in which no passengers are required to be on board to operate the vehicle. An autonomous vehicle may be referred to as a robot vehicle or an automated vehicle. The autonomous vehicle may include passengers, but no driver is necessary. These autonomous vehicles may park themselves or move cargo between locations without a human operator. Autonomous vehicles may include multiple modes and transition between the modes. The autonomous vehicle may steer, brake, or accelerate the vehicle based on the position of the vehicle in order, and may respond to lane marking indicators (lane marking type, lane marking intensity, lane marking color, lane marking offset, lane marking width, or other characteristics) and driving commands or navigation commands. In one embodiment, the vehicle may be assigned with an autonomous level. An autonomous level of a vehicle can be a Level 0 autonomous level that corresponds to a negligible automation for the vehicle, a Level 1 autonomous level that corresponds to a certain degree of driver assistance for the vehicle, a Level 2 autonomous level that corresponds to partial automation for the vehicle, a Level 3 autonomous level that corresponds to conditional automation for the vehicle, a Level 4 autonomous level that corresponds to high automation for the vehicle, a Level 5 autonomous level that corresponds to full automation for the vehicle, and/or another sub-level associated with a degree of autonomous driving for the vehicle.

In one embodiment, a graphical user interface (GUI) may be integrated in the vehicle, which may include assisted driving vehicles such as autonomous vehicles, highly assisted driving (HAD), and advanced driving assistance systems (ADAS). Any of these assisted driving systems may be incorporated into the GUI. Alternatively, an assisted driving device may be included in the vehicle. The assisted driving device may include memory, a processor, and systems to communicate with the GUI. In one embodiment, the vehicle may be an HAD vehicle or an ADAS vehicle. An HAD vehicle may refer to a vehicle that does not completely replace the human operator. Instead, in a highly assisted driving mode, a vehicle may perform some driving functions and the human operator may perform some driving functions. Such vehicle may also be driven in a manual mode in which the human operator exercises a degree of control over the movement of the vehicle. The vehicle may also include a completely driverless mode. The HAD vehicle may control the vehicle through steering or braking in response to the on the position of the vehicle and may respond to lane marking indicators (lane marking type, lane marking intensity, lane marking color, lane marking offset, lane marking width, or other characteristics) and driving commands or navigation commands. Similarly, ADAS vehicles include one or more partially automated systems in which the vehicle alerts the driver. The features are designed to avoid collisions automatically. Features may include adaptive cruise control, automate braking, or steering adjustments to keep the driver in the correct lane. ADAS vehicles may issue warnings for the driver based on the position of the vehicle or based on the lane marking indicators (lane marking type, lane marking intensity, lane marking color, lane marking offset, lane marking width, or other characteristics) and driving commands or navigation commands.

In this example, there is a road construction project 66 obstructing the roadway but the road construction equipment, refuse, etc. may also be adjacent to the roadway 50 in some embodiments. The apparatus 10 uses all this information (e.g., data from the road sign, road construction equipment present, etc.) via the one or more machine learning models to determine if there is a road works project occurring. In this example, it is determined by the apparatus 10 that there is a high likelihood of such a project ahead of the sedan 60. This conclusion may be based on not only the presence of the road work equipment in the actual roadway but also ascertained by the apparatus from the road sign 64. In some embodiments, the apparatus 10 may extract information from the road sign 64 by use of OCR and/or NLP.

In one embodiment, the apparatus 10 may use optical character recognition (“OCR”) in conjunction with one or more databases (see FIG. 2) to determine text of a geographic object. Additionally, the apparatus 10 may compare features or components (such as invariant components relating to a road sign) in or from images to reference features or components in one or more reference databases (or data libraries) to detect a symbol or feature (such as a road works sign diamond symbol). The apparatus 10 may then record (in a database) the determined text, the identified symbols and/or graphics thereof, and/or other features or determinations. For example, the road sign 64 in this case might feature text which says “ROAD WORK AHEAD 500 FEET” along with being a traditional orange roadworks sign. The apparatus 10 can extract this text along with the shape and color of the sign to determine its meaning and content, at least in part, by comparing the current sign to a database of reference information.

As mentioned above, OCR may be used to extract the information from a road sign 64 and natural language processing (NLP) technologies may be used in conjunction with the OCR tools to aid the apparatus 10 in analyzing various signs. NLP may be used in some embodiments to address issues around word segmentation, word removal, and summarization to determine the relevancy of the various parsed data. In various embodiments, semantics of the various parsed data are determined based on a vocabulary model in a grammar module. For example, in various embodiments, probabilistic latent semantic indexing (pLSI) or Latent Dirichlet allocation (LDA) may be used to deduce semantics from words in the extracted road sign text and determine their relevancy. Such methods can be used to derive text and topics from a set of road work terms.

Based off this information, the apparatus may provide to the driver of the sedan 60 an alert (e.g., a high-risk alert) along with route guidance 62 to avoid the road construction project 66. The route guidance 62 provided by the apparatus 10 is shown as an arrow which represents a suggested way to avoid the project (e.g., drive around it in the other lane). This data could also then be used by the apparatus to provide an alert or route guidance to another user in the area or alert the construction crew to oncoming traffic. Since the road is obstructed the suggest route change mintages the risk while in some other examples, automatic braking, etc. may be applied by the apparatus 10 to avoid higher risk situations.

Route guidance may include various guidance options, visual and/or audio. For example, visual guidance on how and when to change lanes or audio guidance relaying the same information. Automatic driver controls like those for an autonomous vehicle (e.g., an automatic lane change that can include an explanation to the passenger on what is happening), etc. The guidance itself can include the alert messages as mentioned above so the generation of alerts and route guidance can be the same function. When calculating the route and route guidance, metadata such as a data flag or attribute of road segments are taken into consideration when forming different suggested routes and one or more segments are excluded from these routes when it is determined (by the apparatus) that one or more roadworks project(s) is associated with the omitted segment(s).

In this example, the exact location of the roadworks project 66 does not match the location of the road sign 64 indicating the presence of roadwork. In most cases, the sign(s) 64 will be located in a location which is proximate to the construction project but not indicative of the exact location of the project. The present apparatus 10 can account for the general location of the project and also its exact start and stop location utilizing the steps discussed above and others. This is useful for routing because in some cases a side street or alternative route may be overlooked if a roadway is marked as being under construction generally without the exact location and extent of the work being know by the apparatus 10.

In some embodiments, apparatus 10 may generate a confidence interval/score which reflects the likelihood a given roadway or navigable link is under construction. In the example above, the apparatus 10 can read the road sign 64 and extract relevant information such as the general area of road work (e.g., that there is road work ahead in 0.5 miles, etc.). From the presence of this sign, the confidence score for the likelihood of road construction on the given roadway may be increased from 0 to 0.25. The apparatus 10 may then receive additional information from other sources (e.g., other cars, traffic cameras, traffic alerts, etc.) which can increase or decrease this confidence score. For example, if the road sign has been captured by 100 other vehicles over the course of several months and there is no corroboration (e.g., no traffic because of the construction, no lanes blocked, no equipment present) the apparatus 10 might lower the confidence score for the likelihood of construction on the roadway from 0.25 to 0.1. Alternatively, if the road construction presence is confirmed by the presence of an actual road works project 66 on a given roadway (e.g., lanes blocked, equipment present, etc.) the confidence interval may be boosted up to 1 as the road sign's information has been confirmed as accurate. This confidence interval can be updated in real time and provide an actuate location for the road works project 66. This is useful for numerous tasks including keeping track of progress of a road resurfacing as the construction crew moves down a roadway, etc.

It should be noted that the examples above are non-limiting and the apparatus, user interface, etc. may be used by pedestrians. For example, if a pedestrian is walking down a hiking trail and the trail was under repair/construction, the apparatus can determine if the trail is undergoing work. Many end users may wish to avoid construction areas for personal safety concerns, congestion of a trail or sidewalk, etc. In embodiments such as this the apparatus may operate in locations (without the need for more traditional vehicles) via trail cameras, end user smart phones, security cameras, etc.

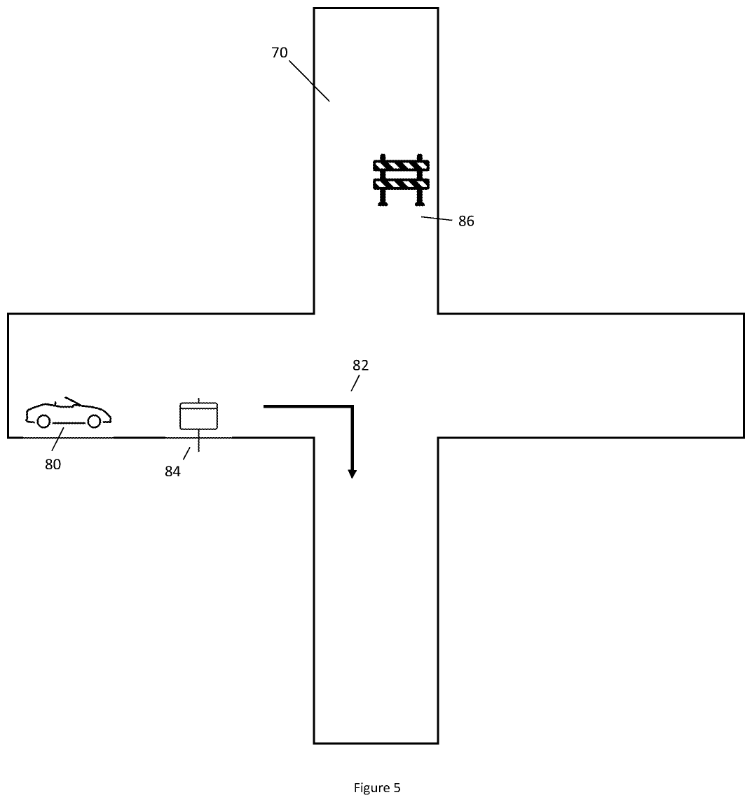

FIG. 5 illustrates another example embodiment. Specifically, a convertible 80 is shown driving down a different roadway 70. This roadway 70 is an intersection and a road construction site 86 is located upon said roadway. Next to the roadway 70 there is a road sign 84 (e.g., an electronic sign board) ahead of the convertible. As shown in FIG. 5, the convertible 80 is utilizing the apparatus 10 to predict if there is a roadworks location in the area. The apparatus 10 identifies the road sign 84 via images from the camera system 22, traffic cameras, etc. and feeds those images into a machine learning model which determines the location of the road work from the information displayed on the road sign 84. The apparatus 10 then takes this data along with relevant other information and generates alerts, routing information, etc.

The apparatus 10 may, in some embodiments utilize optical character recognition (OCR) and/or natural language processing (NLP) to read the road sign 84 and/or reference historical map data to determine the exact location of a roadwork project. If there is a determination made that a roadworks project 86 is obstructing the roadway ahead, the apparatus 10 can provide route guidance 82 to avoid the slowdown such a closed or obstructed roadway might cause.

It should be noted that in the embodiment above the apparatus may predict a higher likelihood of a roadworks project being present on given roadway based on not only the presence of the roadworks sign 84 but also the information detailed on the sign and metadata about the sign. In this example, the apparatus 10 cannot visually confirm the presence of the roadwork ahead as it is on a perpendicular street, but the temporary electronic sign board may state as much (e.g., “NORTHBOUND BUFFALO GROVE ROAD CLOSED AHEAD”). This information may be extracted via OCR/NLP used upon image data captured of the road sign 84. The apparatus 10 may then reference one or more map databases (see FIG. 2) and confirm the location of Buffalo Grove Road proximate to the convertible 80. In this example, the actual location of the road construction is closed heading north, not south meaning the apparatus can route the convertible south along the road away from the construction.

As mentioned in the discussion for FIG. 4, a confidence interval may be generated based on the likelihood that road work is occurring on a given roadway. With the instant example, the apparatus 10 may attribute a confidence score of 0.25 to Northbound Buffalo Grove Road (relative to the location of the road sign 84 and/or convertible 80) as indicated by the text displayed/printed on the sign. The fact that the sign is a temporary electronic sign board and not a generic “ROADWORK AHEAD” sign may also be accounted for by the apparatus 10 and used to boost the confidence interval from 0.25 to 0.75 as there is a good chance the electronic temporary sign board has been set up in response to roadwork happening in real time.

The apparatus 10 may further confirm the presence and location of the roadwork 86 as other cars travel along the roadways proximate to the roadwork site. These cars can, alone and in the aggregate record the location of a given work zone as they travel by it from the North, South, East, and Westbound directions (in this example). Such location data may be record as GPS data or any other functional means. As noted above, if the chance roadwork is present is high (or even confirmed as 100% present, confidence interval 1), the apparatus 10 may generate alerts, provide route guidance, update map layers, and/or implement automatous driving controls in response.

It will be understood that each block of the flowcharts and combination of blocks in the flowcharts may be implemented by various means, such as hardware, firmware, processor, circuitry, and/or other communication devices associated with execution of software including one or more computer program instructions. For example, one or more of the procedures described above may be embodied by computer program instructions. In this regard, the computer program instructions which embody the procedures described above may be stored by a memory device 14 of an apparatus 10 employing an embodiment of the present invention and executed by the processing circuitry 12. As will be appreciated, any such computer program instructions may be loaded onto a computer or other programmable apparatus (for example, hardware) to produce a machine, such that the resulting computer or other programmable apparatus implements the functions specified in the flowchart blocks. These computer program instructions may also be stored in a computer-readable memory that may direct a computer or other programmable apparatus to function in a particular manner, such that the instructions stored in the computer-readable memory produce an article of manufacture the execution of which implements the function specified in the flowchart blocks. The computer program instructions may also be loaded onto a computer or other programmable apparatus to cause a series of operations to be performed on the computer or other programmable apparatus to produce a computer-implemented process such that the instructions which execute on the computer or other programmable apparatus provide operations for implementing the functions specified in the flowchart blocks.

Accordingly, blocks of the flowcharts support combinations of means for performing the specified functions and combinations of operations for performing the specified functions for performing the specified functions. It will also be understood that one or more blocks of the flowcharts, and combinations of blocks in the flowcharts, can be implemented by special purpose hardware-based computer systems which perform the specified functions, or combinations of special purpose hardware and computer instructions.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Furthermore, in some embodiments, additional optional operations may be included. Modifications, additions, or amplifications to the operations above may be performed in any order and in any combination.

Moreover, although the foregoing descriptions and the associated drawings describe example embodiments in the context of certain example combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

1. (canceled)

2. (canceled)

3. (canceled)

4. (canceled)

5. (canceled)

6. (canceled)

7. (canceled)

8. (canceled)

9. (canceled)

10. (canceled)

11. (canceled)

12. (canceled)

13. (canceled)

14. (canceled)

15. (canceled)

16. (canceled)

17. (canceled)

18. (canceled)

19. (canceled)

20. (canceled)

21. A computer-implemented method for providing a roadworks project detection system comprising:
obtaining image data of at least one road sign for a first roadworks project and image data of the first roadworks project from a camera system;
receiving an indication of a location of the vehicle;
utilizing optical character recognition to extract data from the at least one road sign;
determining an exact roadworks project location proximate to the vehicle based on the obtained image data, extracted data, and location of the vehicle, wherein the at least one road sign for the roadworks project is not indicative of the exact location of the first roadworks project;
identifying one or more road segments;
associating the determined exact roadworks project location with one or more of the identified road segments to update a map layer of a geographic database in real time; and
identifying at least one additional exact roadworks project location based on road segments similarly situated to those of the previously determined exact roadworks project location; wherein the at least one additional exact roadworks location identified is based at least in part on the different locations of the at least one road sign for the first roadworks project and first roadworks project.

22. The method according to claim 21, further comprising determining a confidence interval associated with the determined additional exact roadworks project location and updating the map layer with the confidence interval.

23. The method according to claim 22, further comprising updating the confidence interval associated with the determined additional exact roadworks project location based at least in part on the period of time the at least one road sign has been present in a given location and updating the map layer with the confidence interval.

24. The method according to claim 1, further comprising providing an alert in response to the determined additional exact roadworks location to at least one end user device.

25. The method according to claim 1, further comprising providing route guidance in response to the identified additional exact roadworks location.

26. An apparatus configured to predict roadworks location, the apparatus comprising at least one processor and at least one memory storing computer program code, the at least one memory and the computer program code configured to, with the processor, cause the apparatus to at least:
obtain image data of at least one road sign for a first roadworks project and image data of the first roadworks project from a camera system;
receive an indication of a location of the vehicle;
utilize optical character recognition to extract data from the at least one road sign;
determine an exact roadworks project location proximate to the vehicle based on the obtained image data, extracted data, and location of the vehicle, wherein the at least one road sign for the roadworks project is not indicative of the exact location of the first roadworks project;
identify one or more road segments;
associate the determined exact roadworks project location with one or more of the identified road segments to update a map layer of a geographic database in real time; and
identify at least one additional exact roadworks project location based on road segments similarly situated to those of the previously determined exact roadworks project location; wherein the at least one additional exact roadworks location identified is based at least in part on the different locations of the at least one road sign for the first roadworks project and first roadworks project.
